(19) United States
(12) Patent Application Publication
(10) Pub. No.: US 2023/0314625 A1
(43) Pub. Date: Oct. 5, 2023

(54) ENSURING LOCATION INFORMATION IS CORRECT

(71) Applicant: NOKIA TECHNOLOGIES OY, ESPOO (FI)

(72) Inventors: Ryan KEATING, Chicago, IL (US); Jeroen WIGARD, Klarup (DK); István Z. KOVACS, Aalborg (DK); Frank FREDERIKSEN, Klarup (DK)

(21) Appl. No.: 18/023,291

(22) PCT Filed: Aug. 25, 2021
(86) PCT No.: PCT/FI2021/050571

§ 371 Date: Feb. 24, 2023

(30) Foreign Application Priority Data
Aug. 31, 2020 (FI) 20205845

(51) Int. Cl. G01S 19/39; H04B 7/185

(52) U.S. Cl. CPC G01S 19/396; H04B 7/18519

(57) ABSTRACT

Disclosed is a method comprising obtaining information comprising a location of a terminal device, obtaining an angle of arrival (342) of a signal transmitted by the terminal device, determining an expected angle of arrival (344) based, at least partly, on the location of the terminal device, determining if the angle of arrival of the signal transmitted by the terminal device and the expected angle of arrival correspond to each other, and if they do not performing an action associated with an incorrect reported location.

### FIELD

The following exemplary embodiments relate to wireless communication and verifying that obtained information regarding location of a terminal device is correct.

### BACKGROUND

Wireless communication allows devices to freely move from one area to another. The areas may be within one country for example or in different countries or the areas may differ in any other suitable manner. In different areas the policies such as charges and/or services may differ. In order to provide to the terminal device, and on the other hand receive by the terminal device, correct services and to charge correct charges for example it is beneficial to have reasonable confidence that the obtained information regarding the location of the terminal device is correct.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to another aspect there is provided an apparatus comprising means for obtaining information comprising a location of a terminal device, obtaining an angle of arrival of a signal transmitted by the terminal device, determining an expected angle of arrival based, at least partly, on the location of the terminal device, determining if the angle of arrival of the signal transmitted by the terminal device and the expected angle of arrival correspond to each other, and if they do not performing an action associated with an incorrect reported location.

According to another aspect there is provided an apparatus comprising at least one processor, and at least one memory including a computer program code, wherein the at least one memory and the computer program code are configured, with the at least one processor, to cause the apparatus to: obtain information comprising a location of a terminal device, obtain an angle of arrival of a signal transmitted by the terminal device, determine an expected angle of arrival based, at least partly, on the location of the terminal device, determine if the angle of arrival of the signal transmitted by the terminal device and the expected angle of arrival correspond to each other, and if they do not perform an action associated with an incorrect reported location.

According to another aspect there is provided a method comprising obtaining information comprising a location of a terminal device, obtaining an angle of arrival of a signal transmitted by the terminal device, determining an expected angle of arrival based, at least partly, on the location of the terminal device, determining if the angle of arrival of the signal transmitted by the terminal device and the expected angle of arrival correspond to each other, and if they do not performing an action associated with an incorrect reported location.

According to another aspect there is provided a system comprising means for obtaining information comprising a location of a terminal device, obtaining an angle of arrival of a signal transmitted by the terminal device, determining an expected angle of arrival based, at least partly, on the location of the terminal device, determining if the angle of arrival of the signal transmitted by the terminal device and the expected angle of arrival correspond to each other, and if they do not performing an action associated with an incorrect reported location.

According to another aspect there is provided a system comprising an access node and a terminal device, wherein the system further comprises means for obtaining, by the access node, information comprising a location of the terminal device, obtaining, by the access node, an angle of arrival of a signal transmitted by the terminal device, determining, by the access node an expected angle of arrival based, at least partly, on the location of the terminal device, determining, by the access node, if the angle of arrival of the signal transmitted by the terminal device and the expected angle of arrival correspond to each other, and if they do not performing, by the access node, an action associated with an incorrect reported location.

According to another aspect there is provided a computer program product readable by a computer and, when executed by the computer, configured to cause the computer to execute a computer process comprising obtaining information comprising a location of a terminal device, obtaining an angle of arrival of a signal transmitted by the terminal device, determining an expected angle of arrival based, at least partly, on the location of the terminal device, determining if the angle of arrival of the signal transmitted by the terminal device and the expected angle of arrival correspond to each other, and if they do not performing an action associated with an incorrect reported location.

According to another aspect there is provided a computer program product comprising computer-readable medium bearing computer program code embodied therein for use with a computer, the computer program code comprising code for performing obtaining information comprising a location of a terminal device, obtaining an angle of arrival of a signal transmitted by the terminal device, determining an expected angle of arrival based, at least partly, on the location of the terminal device, determining if the angle of arrival of the signal transmitted by the terminal device and the expected angle of arrival correspond to each other, and if they do not performing an action associated with an incorrect reported location.

According to another aspect there is provided a computer program comprising instructions for causing an apparatus to perform at least the following: obtain information comprising a location of a terminal device, obtain an angle of arrival of a signal transmitted by the terminal device, determine an expected angle of arrival based, at least partly, on the location of the terminal device, determine if the angle of arrival of the signal transmitted by the terminal device and the expected angle of arrival correspond to each other, and if they do not perform an action associated with an incorrect reported location.

According to another aspect there is provided a computer readable medium comprising program instructions for causing an apparatus to perform at least the following: obtain information comprising a location of a terminal device, obtain an angle of arrival of a signal transmitted by the terminal device, determine an expected angle of arrival based, at least partly, on the location of the terminal device, determine if the angle of arrival of the signal transmitted by the terminal device and the expected angle of arrival correspond to each other, and if they do not perform an action associated with an incorrect reported location.

According to another aspect there is provided a non-transitory computer readable medium comprising program instructions for causing an apparatus to perform at least the following: obtain information comprising a location of a terminal device, obtain an angle of arrival of a signal transmitted by the terminal device, determine an expected angle of arrival based, at least partly, on the location of the terminal device, determine if the angle of arrival of the signal transmitted by the terminal device and the expected angle of arrival correspond to each other, and if they do not perform an action associated with an incorrect reported location.

### LIST OF DRAWINGS

In the following, the invention will be described in greater detail with reference to the embodiments and the accompanying drawings, in which

FIG. 1 illustrates an exemplary embodiment of a radio access network.

FIG. 2 illustrates an exemplary embodiment of a non-terrestrial network.

FIG. 3a and FIG. 3b illustrate how a satellite may receive signals from terminal devices that are located in different areas.

FIG. 4 and FIG. 5 illustrate flow charts according to exemplary embodiments.

FIG. 6a and FIG. 6b illustrate exemplary embodiments of handovers.

FIG. 7 and FIG. 8 illustrate exemplary embodiments of apparatuses.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus (es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HASP), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

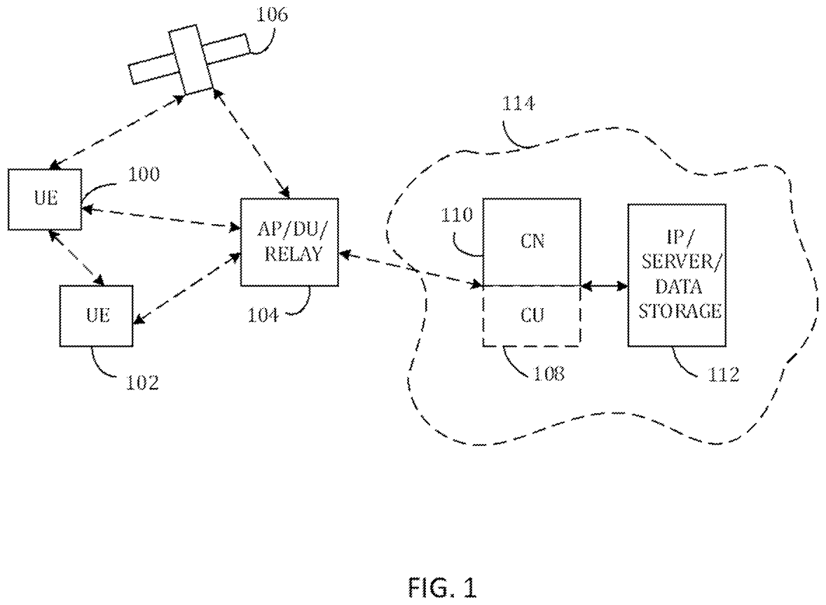

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The access node 104 may also be referred to as a node. The physical link from a terminal device to a (e/g)NodeB is called uplink or reverse link and the physical link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), etc.

The terminal device (also called UE, user equipment, user terminal, user device, etc.) illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise cloud. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require to bring the content close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized. HAPS may be understood as radio stations located on an object at an altitude of 20-50 kilometres and at a fixed point relative to the Earth. For example, broadband access may be delivered via HAPS using lightweight, solar-powered aircraft and airships at an altitude of 20-25 kilometres operating continually for several months for example.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home (e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

Point to multi-point, PTM, transmission may be understood as a transmission in which an access node transmits the same transmission to multiple terminal devices. Multicast and broadcast may be understood as examples of PTM. In Long Term Evolution-Advanced (LTE-A)'s, for example, enhanced Multimedia Broadcast Multicast Service, eMBMS, PTM transmissions may be performed using one cell, in other words using a single cell PTM, SC-PTM, or using MBMS over a single frequency network, MBSFN, transmission that utilizes multiple cells, in other words, utilizes a multi-cell PTM, MC-PTM. The SC-PTM may use radio access parameters for unicast and share the same channels whereas MBSFN may use separate radio access parameters and channels. For 5G, single-cell and multi-cell PTM transmissions may be supported on a common radio access framework with 5G new radio, NR. Such functionality may be called as mixed-mode broadcast.

As cells that are adjacent to each other transmit the same transmission in a multi-cell transmission, there may not be a need to avoid interference, that may occur near the edge of a cell, using inter-cell-interference control measures. As adjacent cells are used to transmit the same transmission, inter-cell interference may be reduced or, in some exemplary embodiments, even a constructive interface may be achieved.

A transmission area may be understood as an area where a service is provided using one or more PTM transmissions. A transmission area may be dynamically configured with various PTM transmissions, such as SC-PTM and/or MC-PTM, within the transmission area. Accordingly, if a service requires data to be transmitted, that may be achieved using various independent SC-PTM and/or MC-PTM transmission schemes. A transmission scheme used may use optimized network settings based on, at least partly, for example distribution of terminal devices within the transmission area. For example, cells that have a large concentration of terminal devices near edges of the cells may utilize MC-PTM and if a cell has high concentration of terminal devices near the centre of the cell, SC-PTM may be utilized.

If SC-PTM and/or MC-PTM transmissions are independent transmissions, they may use their own optimized network settings such as optimized modulation and coding scheme, MCS, and optimized radio resource scheduling, which takes into account factors such as cell load and multiplexing with other services. Therefore, in some exemplary embodiments, progress of transmissions may vary between the independent SC-PTM and/or MC-PTM transmissions. For example, if there are bursts in the transmission, the variation in progress between the independent transmissions may be considerable. If in such exemplary embodiment a terminal device that is receiving the transmission, is located near an edge of a cell and is to move across the cell boundary, it is beneficial to avoid a situation in which a handover or a cell reselection is performed between adjacent cells, wherein the transmission progress of independent PTM transmissions is not synchronized and may thereby cause the terminal device to experience disturbances, such as packet loss, in the transmission it receives. It is to be noted that handover and cell reselection may be both be referred to as mobility. Thus, a terminal device may perform mobility at cell boundaries of independent PTM transmissions. If the independent PTM transmissions are asynchronous, then there is a possibility that packet loss occurs.

Terrestrial wireless networks are useful for allowing mobility. Yet, some limitations in terms of coverage do exist. For example, in rural areas or at sea there may not be access node coverage available. This may be challenging for example in the context of Internet of things, lot when for example buildings, factories, vessels of bridges are to be monitored using IoT and for example 5G. It is envisaged that non-terrestrial network, NTN, may be supported by 5G standards. For example, a 5G access node, a gNB, may be deployed on board satellites to allow coverage to areas that might otherwise not be covered by a cellular communication network, or, in some other examples, an access node, such as the gNB, may be on ground and its signalling is relayed through the satellite. This would enable 5G signals to be beamed down from space thereby enhancing the terrestrial infrastructure of a wireless communication network. It would also help to improve reliability of wireless communication during disasters such as earthquakes that may damage the terrestrial access nodes for example.

Various types of satellites exist. For example, some satellites have been in orbit for decades and may operate 36 000 kilometres above the Earth. Some satellites are considered as Low Earth Orbit, LEO, satellites. Such satellites may operate between 500 and 2000 kilometres above the Earth. Some LEO satellites operate at approximately 600 kilometres above the Earth. A low orbit allows latency to be reduced as the satellite may be in positioned to quickly receive and transmit data. The footprint of a LEO satellite may be between 100-1000 km radius which may allow the footprint to cover an area on Earth that includes multiple countries. It is to be noted though that as the coverage area of the LEO satellite is after all limited, a handover may be performed between two LEO satellites.

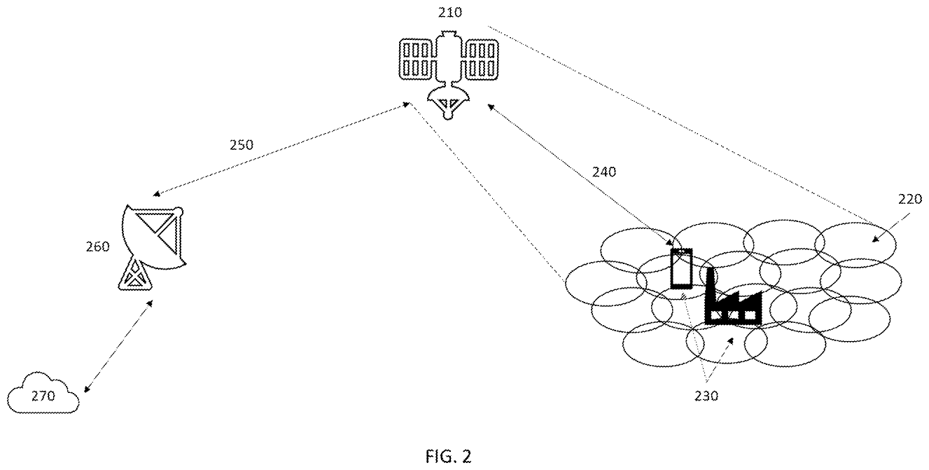

FIG. 2 illustrates an exemplary embodiment of a non-terrestrial network, NTN. In this exemplary embodiment, a LEO satellite 210 is deployed with at least one gNB. The dashed lines indicate the field of view of the LEO satellite 210. The elliptical shape 220 illustrates a beam footprint. The LEO satellite 210 may utilize multiple spot beams and frequency reuse to achieve more precise beams. The coverage of such beams is smaller that the field of view of the satellite. Yet, the spot beams may enable increased throughput capabilities. One or more terminal devices 230, for example a mobile user device or a smart factory comprising multiple IoT devices, are to be served by a service link 240 that provides a connection to the gNB deployed in the LEO satellite 210. There is a feeder link 250 between the LEO satellite 210 and a gateway 260. The gateway then provides a connection to a data network 270.

As a satellite may cover areas that are divided for example by a border between two countries or a border of another kind such as a border between different parts within a country, it is beneficial to be aware of the location of the terminal device that is being served by a gNB deployed in the satellite.

In order to determine the location of a terminal device, Global Navigation Satellite System, GNSS, may be utilized. GNSS comprises satellites that orbit around the Earth and send signals that may be received by the terminal device and used as a basis for determining the location of the terminal device. A signal transmitted by a satellite comprised in the GNSS comprises data regarding positioning and timing. The signal may be transmitted from the satellite along a line of site using one or more carrier waves. The accuracy of the determined position may vary. To enable determining a more precise position, the GNSS may be enhanced. Differential GNSS is an example of such enhancement. Differential GNSS may further be enhanced by a phase of the satellite carrier wave is measured. Combining the carrier wave measurement with the determined error enables determining a location at an accuracy that may be for example up to 1 centimetre or below. This may be called as real-time kinematic, RTK, positioning. Various satellite-based positioning systems have been developed based on GNSS, which may also be considered as a satellite-based positioning system, or its enhanced versions. Examples of such satellite-based positioning systems comprise for example, Global Positioning System GPS, Russian Global Navigation Satellite System, GLOSNASS, and Chinese Satellite Navigation System BeiDou.

A terminal device that is to be served may be asked to report its location. The location information may be needed for various purposes, for example to connect the terminal device to correct country, MCC, and/or to correct network, PLMN, thereby allowing correct charging and content policies to be deployed for example, to verify that correct radio parameters, such as mobility settings are deployed, and/or to be able to connect to the correct emergency services in case such are needed.

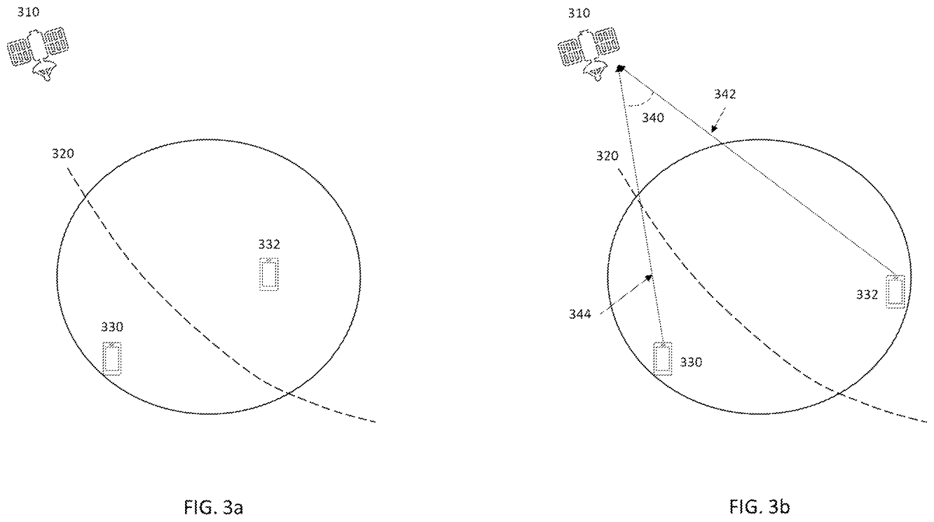

Yet, there may be a possibility for the terminal device to falsify a GNSS location report that it reports to a satellite. Such an exemplary embodiment is illustrated in FIG. 3a. A satellite 310, which may be a LEO satellite comprising a gNB, serves a terminal device that in this exemplary embodiment comprises a capability to report its location using GNSS based location information. The satellite 310 covers an area that includes a border 320 between two countries. In this exemplary embodiment, the terminal device has reported its location to be location 330, while its actual location is location 332. In other words, information comprising location of the terminal device comprises location 330, which in this exemplary embodiment is not correct. Instead, correct information comprising the location of the terminal device would comprise location 332.

There may be various manners that result in incorrect location to be reported by the terminal device. Some of such manners may be intentional while other may be unintentional. For example, GNSS location reports may be falsified and/or jammed. Further, in addition to falsifying the GNSS report, the terminal device may also falsify timing advance of its transmission such that it mimics the false location it has reported to the satellite 310. Thus, it is beneficial to be able to verify if the reported GNSS location is correct or not.

Angle of arrival, AoA, of a signal is the direction from which the signal is received by a receiver. AoA may be measured for example by determining the direction of propagation of a radio-frequency wave incident on an antenna array or AoA may be determined from maximum signal strength during antenna rotation. Further, an AoA may be calculated by measuring the time difference of arrival, TDOA, between individual elements of an antenna array. When measuring the AoA, various algorithms, such as super-resolution algorithms like MUSIC and/or other algorithms utilizing MIMO arrays, may be used. In some exemplary embodiments, the algorithms may provide the most accurate results when there is a line of sight, LoS, between the satellite 310 and the terminal device.

If an AoA is obtained at the satellite 310 for one or more signals received from the terminal device and the obtained AoA is then compared with the location, determined using GNSS, the terminal device has reported, it may be determined if the difference between the reported location and the obtained AoA is such that the reported location may be verified to be correct or not. FIG. 3b illustrates an exemplary embodiment of verifying the location information comprising the location of the terminal device by obtaining the AoA of the signal transmitted by the terminal device. The satellite 310 receives in this exemplary embodiment information comprising the location 330 as the location of the terminal device being served. The location 330 however is not correct and is in fact on the other side of the border 320 than the real location 332 of the terminal device. When a signal, or a plurality of signals, is received by the satellite 320 from the terminal device, the AoA in view of the real location 332 may be obtained. On the other hand, an expected AoA may be determined based on the reported location. The angle 340 between the AoA 342 from the location 332 and the AoA 344 from the location 330 may thus be determined. If the angle is more than a threshold value, which may be pre-determined, then it may be determined that the information comprising the location 330 as the location of the terminal device may not be correct. A benefit of obtaining the AoA, by calculating and/or determining in any suitable manner, is that a terminal device may not be capable of falsifying the AoA.

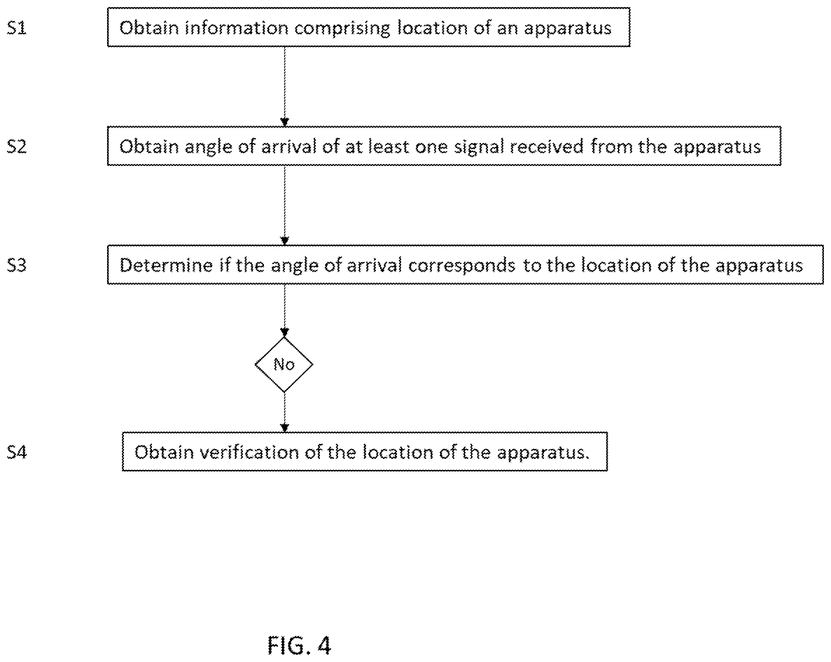

FIG. 4 illustrates a flow chart according to an exemplary embodiment. First, in S1, information comprising a location of an apparatus is obtained. The information may be obtained by a satellite comprising an access node such as a gNB. The satellite may serve the apparatus, which may be a terminal device that is compatible with 5G network for example. The apparatus may further be capable of determining its location using a GNSS based determination of its location. The location information may be obtained for example if the apparatus provides a report comprising information that comprises the location of the apparatus.

Next, in S2, an AoA of one or more uplink signals transmitted by the apparatus and received at the gNB comprised in the satellite may be obtained. The AoA may be obtained for example from Physical Random Access Channel, PRACH, or from sounding reference system, SRS. The AoA may be obtained with a certain resolution such as 1 degree. Then, in S3, it is determined if the location and the obtained AoA correspond to each other. Based on the obtained information comprising the location of the apparatus and the location of the satellite, which is known in this exemplary embodiment, an expected AoA of the apparatus may be calculated at the satellite. If the calculated expected AoA is the same as the obtained AoA, or their deviation is less than a threshold amount, which may be pre-determined, it may be determined that the location and the obtained AoA correspond to each other and therefore the location may be considered as correct. On the other hand, if the deviation is more than the threshold value, it may be determined that the location and the AoA do not correspond to each other and therefore the location, which is a reported location, may be considered to be incorrect. Consequently, an action associated with an incorrect reported location may be performed.

If the location is considered as incorrect, then in S4 a verification of the location of the apparatus is obtained. Obtaining the verification of the location of the apparatus may be considered as an example of an action associated with an incorrect reported location and may further comprise triggering a verification algorithm for example. The verification of the location may be obtained by any suitable manner. For example, inputs relating to the apparatus and being available to the gNB may be utilized. Such inputs may comprise for example measurement reports such as reference signal received power, RSRP, of serving and neighboring cells, Timing Advance, TA, of the apparatus for a given time window, Doppler offset in the uplink of the connection currently and/or in the past, location of the satellite and/or location of the apparatus during one or more past handovers as well as the timing of such handovers. For earth moving cells, which may have frequent semi-deterministic handovers location of the satellite and/or location of the apparatus during one or more past handovers as well as the timing of such handovers may be useful when determining if the apparatus is not in the location it is reporting to be in. Use of AoA for determining if a correct location of the apparatus is to be obtained may be beneficial as the apparatus may not falsify AoA at the satellite like it may falsify other parameters such as timing. AoA measurements may optionally be tracked over time using for example filtering, to further improve accuracy of determining if the reported location is not correct and a correct location is to be obtained. Additionally, or alternatively, in some exemplary embodiments, a learning algorithm may be used for increased accuracy of determining if the reported location is not correct. Further, in some exemplary embodiments, a terminal device may report one or more measurements that comprise a time stamp. Such time stamp indicates a time when the measurement was obtained by the terminal device. Thus, one or more measurements comprising a time stamp may be compared to the location that the terminal device has reported. If the time stamps and the reported location correspond, it may be determined that the reported location is correct and if they do not correspond, then it may be determined that the reported location may not be correct. Additionally, or alternatively, in some exemplary embodiments, the time stamp may be added by the gNB at the time of receiving a measurement report from the terminal device. This may be beneficial also for tracing and may also help mitigating potential falsification of time stamps by the terminal device.

Once the correct location has been obtained, it may be that the reported location is determined to be correct. Alternatively, it may be determined that the reported location is not correct, or it is not sufficiently accurate according to criterion that may be pre-determined. If the reported location is not correct or accurate enough, it may be that no action is performed. Yet, in some exemplary embodiments, the apparatus may be scheduled for additional UL transmissions such as SRS to improve AoA filter. Alternatively, or additionally, in some exemplary embodiments, the apparatus may be barred from the network comprising the gNB, or the apparatus may be notified to report its location again. Yet, alternatively or additionally, in some exemplary embodiments, the apparatus may be notified that the reported location is determined to be incorrect. Further, alternatively or additionally, in some exemplary embodiments the gNB may fall back to the last correct location of the apparatus in case it has been obtained less than a certain threshold time ago. Further, alternatively or additionally, in some exemplary embodiments the gNB may impose network restrictions related to content, temporarily or permanently for the apparatus, according to the worst case of the overall coverage area. In a similar manner, the network may impose charging according to the highest rate for the intended coverage area for example.

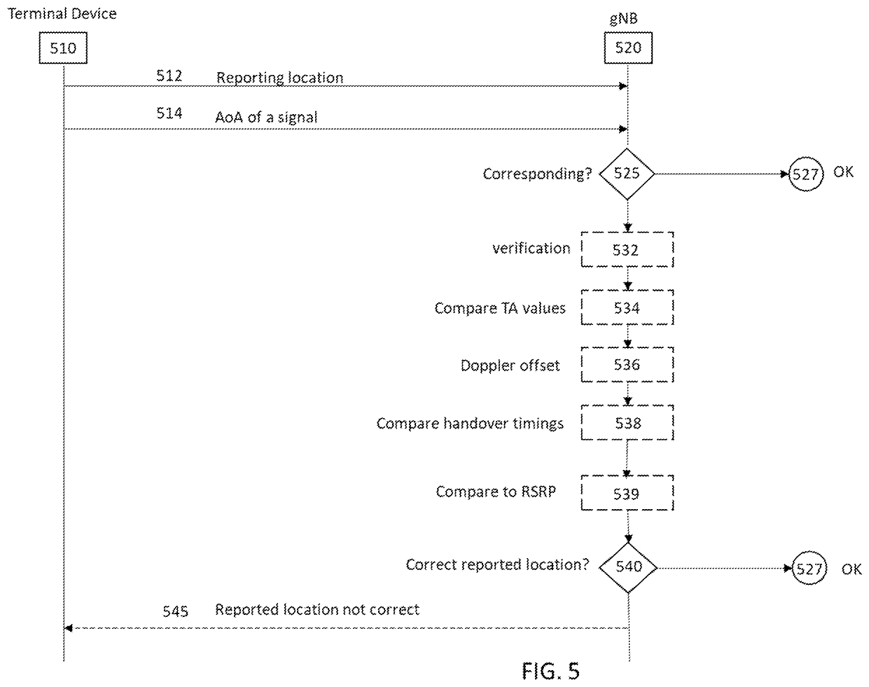

FIG. 5 illustrates an exemplary embodiment of obtaining a correct location of an apparatus 510, which in this exemplary embodiment is a 5G capable terminal device, that is served by an access node 520, which in this exemplary embodiment is a gNB that is comprised in a satellite such as a LEO satellite. First, in 512, the apparatus 510 reports its location to the access node 520. Thus, the access node 520 obtains first information that comprises a location of the apparatus 510. Based on the location, an expected AoA may be determined. Next, in 514, an AoA of a signal received from the apparatus may be determined. It is to be noted that in some alternative exemplary embodiments, the AoA may be determined first and after that the first information that comprises a location of the apparatus 510 may be obtained and the expected AoA may be determined.

In 525 then the expected AoA and the obtained AoA are compared to determine if they correspond to each other. The expected AoA and the obtained AoA may be considered as corresponding to each other in case they deviate from each other less than a threshold amount. If they are corresponding, then verification may not be needed 527. On the other hand, if the expected AoA and the obtained AoA do not correspond to each other, then a correct location of the apparatus may be obtained by for example triggering a verification algorithm. In some exemplary embodiments, the verification algorithm may comprise a plurality of algorithms. It is also to be noted that the threshold amount may be determined at least partly such that the AoA measurement accuracy expected for a certain antenna configuration, the number of AoA measurements used for averaging, and/or the requirements for position detection accuracy are taken into account. For example, the threshold amount could correspond to one degree averaged over three AoA measurements. In some exemplary embodiments, additionally or alternatively, the selection of the threshold amount may also depend on the location on earth, as in some areas the location may be more critical than in other areas.

In 532 it has been determined that the expected AoA and the obtained AoA do not correspond to each other, and the verification algorithm is triggered. The verification algorithm may compare the RSRP reported by the apparatus with the RSRP of one or more other apparatuses located in similar locations than the reported location of the apparatus as well as expected RSRP values which may be estimated based on the ephemeris data of the satellite and relative location of the apparatus within the beam coverage. In some exemplary embodiments, additionally or alternatively, the RSRP reported by the apparatus may also be compared to one or more RSRPs previously reported by the apparatus. The apparatus may be requested to provide updated L1 or L3 RSRP values as well. It may also be possible that both RSRP values for the serving cell and neighbor cells could be utilized. In some exemplary embodiments, when the apparatus reports its location that is determined based on GNSS, an indication of the quality of the GNSS reception may be included in the report. In other words, the information comprising the location of the apparatus may comprise information regarding the quality of the GNSS reception as well. Hence, other one or more apparatuses that are no longer able to detect the accurate GNSS location may be assumed to be within the vicinity of the last reported location, for example at least within a certain maximum time, which may for example be set by the gNB based on the area the UE is in. Further, in some exemplary embodiments, the apparatus may not be able to find its GNSS location. This may be the case for example if the apparatus is indoors. In such an exemplary embodiment, the apparatus may also fall back to the last known location, for example at least for a certain maximum time, which potentially may be set for example by the gNB based on the area the apparatus is located in. Additionally, or alternatively, in some exemplary embodiments, the gNB may then use other metrics such as RSRP and/or handover, to verify that the fallback location is considered as acceptable. It is to be noted that in some exemplary embodiments, for one or more apparatuses mobility may be assumed to be relatively low so that if a prior reported location is verified, and subsequently relied on for a window of time, it is considered safe to assume that apparatus has not moved more than a threshold distance. For example, it is assumed that the apparatus has not moved 100 km away from the prior reported location.

Next in 534, additionally or alternatively, the verification algorithm may compare a TA value of the apparatus calculated by the gNB based on UL signals received from the apparatus to a TA that is expected based, at least partly, on the reported location of the apparatus.

In 536, additionally or alternatively, a Doppler offset of the uplink signal may be utilized. The Doppler offset of the uplink signal, that is received by the access node 520 from the apparatus 510, depends on the location of the apparatus 510 relative to the satellite, and its movement vector, and may therefore also be used to obtain additional information regarding correct location of the apparatus 510.

Further in 538, additionally or alternatively, in some exemplary embodiments, timing of handovers performed for the apparatus 510 may also be compared with an expected time of handover for the reported location of the apparatus 510.

Further in 539, additionally or alternatively, in some exemplary embodiments, the RSRP reported by the apparatus 510 is compared. The comparison may be done to one or more values previously reported by the apparatus 510 and/or to RSRP values reported by one or more other apparatuses.

The comparisons 532, 534, 536, 568 and 539 may all be comprised in a verification algorithm or one or more of them may be comprised in the verification algorithm. Once the verification algorithm has been executed, a determination 540 may be performed regarding if the reported location of the apparatus 510 is correct or not. The determination 540 may further be based on one or more of the following aspects: time, reported location of the apparatus 510 that is determined based on GNSS, and/or the measured AoA of a signal transmitted by the apparatus 510 and received by the access node 520. If it is determined that the reported location is correct, then the process of obtaining the correct location may end 527. On the other hand, if it is determined that the reported location was not correct, then, in some exemplary embodiments, this may be reported to the apparatus 510 by transmitting a message 545 indicating that the location was not correct. Alternatively, or additionally, further actions may also be taken such that the service provided to the apparatus 510 is limited or barred.

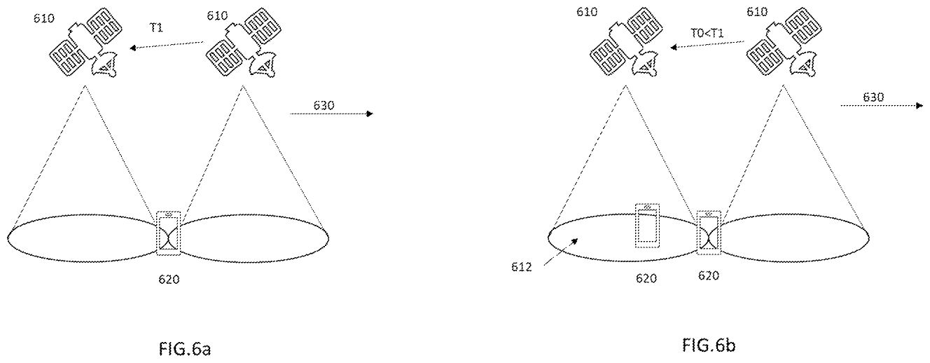

Comparison of timing of handovers may be beneficial for Earth moving cells. This is illustrated in FIGS. 6a and 6b. FIG. 6a illustrates a handover of an apparatus 620 from a LEO satellite 610 comprising a gNB to another. The apparatus 620 experiences the handover at time T1 when the beam coverage of two LEO satellites 620 shifts at its location. FIG. 6b illustrates an exemplary embodiment in which the apparatus 620 is reporting a different location within the cell but then is experiencing a handover at time TO prior compared to when it should if its reported location was correct. In this exemplary embodiment, the reported location is within the coverage area 612 although the correct location is at the shift of the coverage areas provided by the LEO satellites. In FIGS. 6a and 6b the direction of the handover is illustrated by arrow 630.

In a further exemplary embodiment, tracking of an expected location compared to a reported location of an apparatus is handled across multiple gNBs comprised in a LEO satellites respectively. Thus, after a plurality of handovers that occur between satellites in different orbits, an understanding shared by the multiple gNBs of the expected and reported AoA of the apparatus may be achieved. This may be beneficial for improving a detection algorithm.

It should be noted that even though the exemplary embodiments described above focus on the satellite perspective, the verification approach introduced in the above exemplary embodiments may be applied to any network system that is subject to differential behavior. That is, network systems that are subject to either content restrictions, charging differences, or similar constraints. Such AoA validation principles could be applied to for example high altitude platform systems, HAPS, and/or terrestrial networks around border zones.

An advantage of the above described exemplary embodiments may be the ability to detect apparatuses, that may be terminal devices, which are reporting unreliable and/or low accuracy location information, without a need to run a verification algorithm on all apparatuses served by the satellite comprising a gNB. The number of apparatuses in one cell provided by a satellite comprising a gNB may be quite large. Thus, computational resources may be used in a more conscious manner as the verification algorithm is run related to such apparatuses that have measured AoA differing from the expected AoA. GNSS based location verification may be useful for applying different country/region charging policies, country identification for regulatory purposes and emergency services protection for example. It is to be noted that in some exemplary embodiments the output of determining if the reported location is correct may be provided as a probability of the reported location being incorrect. This may be understood as a soft output. Further, in some exemplary embodiments, if the angle of arrival of the signal transmitted by a terminal device and an expected angle of arrival do not correspond to each other, an action may be performed based on determining that the location was incorrect without verifying the location first.

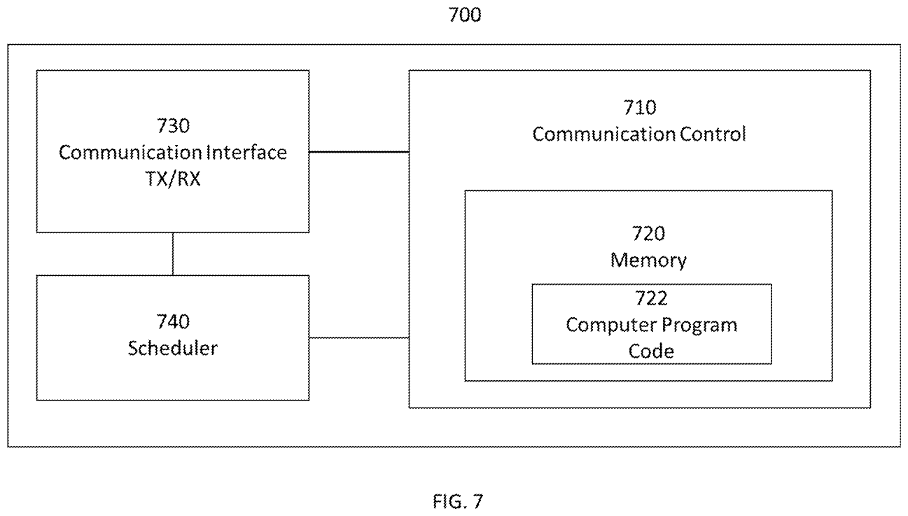

The apparatus 700 of FIG. 7 illustrates an example embodiment of an apparatus that may be an access node or be comprised in an access node. The apparatus may be, for example, a circuitry or a chipset applicable to an access node to realize the described embodiments. The apparatus 700 may be an electronic device comprising one or more electronic circuitries. The apparatus 700 may comprise a communication control circuitry 710 such as at least one processor, and at least one memory 720 including a computer program code (software) 722 wherein the at least one memory and the computer program code (software) 722 are configured, with the at least one processor, to cause the apparatus 700 to carry out any one of the example embodiments of the access node described above.

The memory 720 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store current neighbour cell list, and, in some example embodiments, structures of the frames used in the detected neighbour cells.

The apparatus 700 may further comprise a communication interface 730 comprising hardware and/or software for realizing communication connectivity according to one or more communication protocols. The communication interface 730 may provide the apparatus with radio communication capabilities to communicate in the cellular communication system. The communication interface may, for example, provide a radio interface to terminal devices. The apparatus 700 may further comprise another interface towards a core network such as the network coordinator apparatus and/or to the access nodes of the cellular communication system. The apparatus 700 may further comprise a scheduler 740 that is configured to allocate resources.

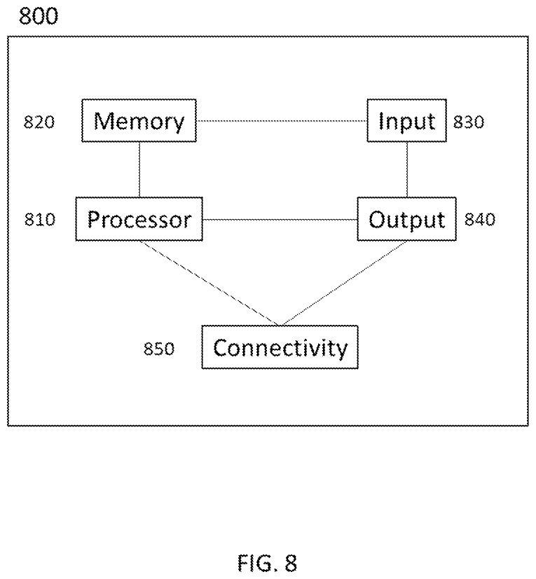

FIG. 8 illustrates an apparatus 800, which may be an apparatus such as, or comprised in, a terminal device, according to an example embodiment. The apparatus 800 comprises a processor 810. The processor 810 interprets computer program instructions and processes data. The processor 810 may comprise one or more programmable processors. The processor 810 may comprise programmable hardware with embedded firmware and may, alternatively or additionally, comprise one or more application specific integrated circuits, ASICs.

The processor 810 is coupled to a memory 820. The processor is configured to read and write data to and from the memory 820. The memory 820 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 820 stores computer readable instructions that are execute by the processor 1810. For example, non-volatile memory stores the computer readable instructions and the processor 810 executes the instructions using volatile memory for temporary storage of data and/or instructions.

The computer readable instructions may have been pre-stored to the memory 820 or, alternatively or additionally, they may be received, by the apparatus, via electromagnetic carrier signal and/or may be copied from a physical entity such as computer program product. Execution of the computer readable instructions causes the apparatus 800 to perform functionality described above.

In the context of this document, a “memory” or “computer-readable media” may be any non-transitory media or means that can contain, store, communicate, propagate or transport the instructions for use by or in connection with an instruction execution system, apparatus, or device, such as a computer.

The apparatus 800 further comprises, or is connected to, an input unit 830. The input unit 830 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 830 may comprise an interface to which external devices may connect to.

The apparatus 800 also comprises an output unit 840. The output unit comprises or is connected to one or more displays capable of rendering visual content such as a light emitting diode, LED, display, a liquid crystal display, LCD and a liquid crystal on silicon, LCoS, display. The output unit 840 may comprise two displays to render stereoscopic visual content. One display to render content to the left eye and the other display to render content to the right eye. The output unit 840 may further comprise a transmission unit, such as one or more waveguides or one or more lenses, to transfer the rendered visual content to the user's field of view. The output unit 840 further comprises one or more audio outputs. The one or more audio outputs may be for example loudspeakers or a set of headphones.

The apparatus 800 may further comprise a connectivity unit 850. The connectivity unit 850 enables wired and/or wireless connectivity to external networks. The connectivity unit 850 may comprise one or more antennas and one or more receivers that may be integrated to the apparatus 800 or the apparatus 800 may be connected to. The connectivity unit 850 may comprise an integrated circuit or a set of integrated circuits that provide the wireless communication capability for the apparatus 800. Alternatively, the wireless connectivity may be a hardwired application specific integrated circuit, ASIC.

It is to be noted that the apparatus 800 may further comprise various component not illustrated in the FIG. 8. The various components may be hardware component and/or software components.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising:
at least one processor; and
at least one memory including computer program code, wherein the at least one memory and the computer program code are configured, with the at least one processor, to cause the apparatus to:
obtain information comprising a location of a terminal device;
obtain an angle of arrival of a signal transmitted by the terminal device;
determine an expected angle of arrival based, at least partly, on the location of the terminal device;
determine if the angle of arrival of the signal transmitted by the terminal device and the expected angle of arrival correspond to each other, and if they do not
perform an action associated with an incorrect reported location, wherein the action associated with the incorrect reported location comprises obtaining a verification of the location of the terminal device by executing a verification algorithm that comprises one or more of the following:
comparing a reference signal received power reported by the terminal device to reference signal received power reported by one or more other terminal devices;
comparing a reference signal received power reported by the terminal device to reference signal received power reported by the terminal device previously;
comparing a timing advance value determined based on the location of the terminal to a timing advance value determined based on one or more uplink signals transmitted by the terminal device;
determining if a Doppler offset of an uplink signal received from the terminal device corresponds to the location;
determining if a time stamp of one or more measurements reported by the terminal corresponds to the location; and
determining if a handover takes place at a time that corresponds to the location.

2. The apparatus according to claim 1, wherein the angle of arrival of the signal transmitted by the terminal device and the expected angle of arrival correspond to each other if a deviation between them is less than a threshold value.

3-5. (canceled)

6. The apparatus according to claim 1, wherein the verification of the location determines the location to be incorrect.

7. The apparatus according to claim 1, wherein the verification of the location determines a probability for the location to be incorrect.

8. The apparatus according to claim 6, wherein the apparatus is further caused to perform at least one of the following:
schedule the terminal device for an additional uplink transmission;
notify the terminal device to report its location;
impose network restrictions to the terminal device; and/or
deny access to network from the terminal device.

9. The apparatus according to claim 1, wherein the location is obtained at least partly based on global navigation satellite system by the terminal device.

10. The apparatus according to claim 1, wherein determining the expected angle of arrival further comprises filtering over time.

11. The apparatus according to claim 1, wherein the apparatus is comprised in a gNB.

12. The apparatus according to claim 1 wherein the apparatus is comprised in a satellite.

13. A method comprising:
obtaining information comprising a location of a terminal device;
obtaining an angle of arrival of a signal transmitted by the terminal device;
determining an expected angle of arrival based, at least partly, on the location of the terminal device;
determining if the angle of arrival of the signal transmitted by the terminal device and the expected angle of arrival correspond to each other, and if they do not
performing an action associated with an incorrect reported location, wherein the action associated with the incorrect reported location comprises obtaining a verification of the location of the terminal device by executing a verification algorithm that comprises one or more of the following:
comparing a reference signal received power reported by the terminal device to reference signal received power reported by one or more other terminal devices;
comparing a reference signal received power reported by the terminal device to reference signal received power reported by the terminal device previously;
comparing a timing advance value determined based on the location of the terminal to a timing advance value determined based on one or more uplink signals transmitted by the terminal device;
determining if a Doppler offset of an uplink signal received from the terminal device corresponds to the location;
determining if a time stamp of one or more measurements reported by the terminal corresponds to the location; and
determining if a handover takes place at a time that corresponds to the location.

14. A non-transitory computer readable medium comprising program instructions for causing an apparatus to perform at least the following:
obtain information comprising a location of a terminal device;
obtain an angle of arrival of a signal transmitted by the terminal device;
determine an expected angle of arrival based, at least partly, on the location of the terminal device;
determine if the angle of arrival of the signal transmitted by the terminal device and the expected angle of arrival correspond to each other, and if they do not
perform an action associated with an incorrect reported location, wherein the action associated with the incorrect reported location comprises obtaining a verification of the location of the terminal device by executing a verification algorithm that comprises one or more of the following:
comparing a reference signal received power reported by the terminal device to reference signal received power reported by one or more other terminal devices;
comparing a reference signal received power reported by the terminal device to reference signal received power reported by the terminal device previously;
comparing a timing advance value determined based on the location of the terminal to a timing advance value determined based on one or more uplink signals transmitted by the terminal device;
determining if a Doppler offset of an uplink signal received from the terminal device corresponds to the location;
determining if a time stamp of one or more measurements reported by the terminal corresponds to the location; and
determining if a handover takes place at a time that corresponds to the location.

15. (canceled)

16. A system comprising:
an access node, which is comprised in a satellite; and
a terminal device,
wherein the system is configured to:
obtain, by the access node, information comprising a location of a terminal device;
transmit, by the terminal device, a signal;
obtain, by the access node, an angle of arrival of a signal transmitted by the terminal device;
determine, by the access node an expected angle of arrival based, at least partly, on the location of the terminal device;
determine, by the access node, if the angle of arrival of the signal transmitted by the terminal device and the expected angle of arrival correspond to each other, and if they do not
perform, by the access node, an action associated with an incorrect reported location, wherein the action associated with the incorrect reported location comprises obtaining a verification of the location of the terminal device by executing, by the access node, a verification algorithm that comprises one or more of the following:
comparing a reference signal received power reported by the terminal device to reference signal received power reported by one or more other terminal devices;
comparing a reference signal received power reported by the terminal device to reference signal received power reported by the terminal device previously;
comparing a timing advance value determined based on the location of the terminal to a timing advance value determined based on one or more uplink signals transmitted by the terminal device;
determining if a Doppler offset of an uplink signal received from the terminal device corresponds to the location;
determining if a time stamp of one or more measurements reported by the terminal corresponds to the location; and
determining if a handover takes place at a time that corresponds to the location.

17. An apparatus according to claim 1, wherein determining the expected angle of arrival further comprises utilizing a learning algorithm.

18. An apparatus according to claim 1, wherein the verification algorithm further comprises comparing timing of handovers performed for the terminal device with an expected time of a handover for the location of the terminal device.
